(19) United States
(12) Patent Application Publication
(10) Pub. No.: US 2016/0263968 A1
(43) Pub. Date: Sep. 15, 2016

(54) ADJUSTABLE DOOR GLASS ATTACHMENT BRACKET

(71) Applicant: FORD GLOBAL TECHNOLOGIES, LLC, Dearborn, MI (US)

(72) Inventors: Paul Lawrence Lipinski, Canton, MI (US); Wolfgang Frank Loewe, Livonia, MI (US)

(21) Appl. No.: 14/642,787

(22) Filed: Mar. 10, 2015

(51) Int. Cl. B60J 1/00; E05F 15/00; E05F 11/38

(52) U.S. Cl. CPC B60J 1/006; E05F 11/385; E05F 15/00; E05Y 2900/50; E05Y 2600/626

(57) ABSTRACT

A glass panel attachment bracket for a vehicle includes a receiver for receiving at least a portion of a glass panel. The receiver includes at least one adjustable fastener adapted for impinging on a surface of the portion of the glass panel received in the receiver. Motor vehicle door window glass mounting assemblies and methods for assembling a glass panel and a glass panel attachment bracket incorporating the glass panel attachment bracket are described.

### TECHNICAL FIELD

This disclosure relates generally to glass panels for motor vehicles. More particularly, the disclosure relates to an adjustable attachment bracket for a glass panel, the bracket including a retainer for preventing unwanted movement of the glass relative to the bracket during adhesive curing.

### BACKGROUND

In, for example, motor vehicle door assemblies including movable motorized windows, it is common to provide window mounting and regulator assemblies which are raised and lowered within a door cavity by a variety of motorized mechanisms to open and/or close a window glass panel. Typically an attachment bracket (having a variety of known designs) is provided to attach the window glass panel to the window glass mounting and regulator assembly.

Conventional glass and bracket designs, for example for motor vehicle door glass panels, locate the attachment bracket to the glass panel by surface contact for inboard/outboard location (Y-datum) and assembly fixture location for up/down location (Z-datum). In the assembly process, adhesive is applied to the bracket prior to locating the bracket to the glass panel. Typical adhesives used in the automotive industry for securing glass panels to attachment brackets require an extended curing time (for example, 72 hours). However, during manufacture the typical process is to remove the glass/attachment bracket assembly from the assembly fixture prior to full curing of the adhesive. This undesirably allows the bracket and glass to shift or move relative to one another during subsequent processing and packaging steps. Such shifting or movement results not only in a part of poor quality, but also may compromise fit and function of the glass panel in the motor vehicle environment, for example during assembly of a vehicle door including the glass panel.

One possible solution to this problem that has been considered is to provide additional or alternative means for attaching the attachment bracket to the glass panel. For example, one possible alternative is to provide one or more apertures in the glass panel for receiving a fastener associated with the attachment bracket, to maintain the relative positions of the attachment bracket and the glass panel during adhesive curing. However, such apertures weaken the structure of the glass panel, risking damage to the panel during subsequent assembly processes. As a result, a need exists for improvements to glass panel attachment brackets.

### SUMMARY

In accordance with the purposes and benefits described herein, an adjustable attachment bracket for a glass panel is provided. The attachment bracket includes a retainer for preserving a relative position of the glass panel and the bracket, allowing a precise location and retention of the attachment bracket to the glass panel and to glass datums during assembly of the attachment bracket to the glass panel. In turn, this retainer providing precise location and retention preserves the location of the attachment bracket to the glass panel during adhesive curing, even as the glass panel/bracket proceed through subsequent processing and packaging steps.

In one aspect of the present disclosure, an adjustable glass panel attachment bracket is described. The bracket includes a receiver for receiving at least a portion of a glass panel. The receiver in turn includes at least one adjustable fastener adapted for impinging on a surface of the portion of the glass panel received in the receiver. The receiver includes a bottom and may include two opposed walls defining a slot configured to receive the portion of the glass panel therein. One of the opposed walls includes at least one aperture for receiving the at least one adjustable fastener therethrough. In embodiments, the at least one adjustable fastener engages the at least one aperture by an interference fit, a friction fit, a press fit, a snap fit, a ratcheting surface, or a screwthread. The other of the opposed walls may include at least one aperture for receiving a glass panel support boss therethrough. In embodiments, the receiver is carried by an arm including at least one aperture therethrough.

In another aspect of the disclosure, a motor vehicle door window glass mounting assembly is described. The assembly includes a base adapted for raising and lowering within a cavity defined in the motor vehicle door. At least one adjustable glass panel attachment bracket as described above is mounted to the base, thereby providing a mechanism for securing a glass panel to the vehicle door.

In yet another aspect of the disclosure, a method is described for securing one or more glass panel attachment brackets according to the present disclosure to a glass panel. The method includes applying a first adhesive is applied to an interior of the attachment bracket receiver. A second adhesive is applied to a surface of the adjustable fastener that will impinge on a mating surface of the glass panel. The second adhesive curing time is less than the curing time of the first adhesive. One or more glass panel attachment brackets are disposed at predetermined positions on an edge of the glass panel, and the at least one adjustable fastener of each bracket is advanced to impinge on the glass panel. The predetermined bracket positions may be determined by a template defined by one or more glass panel attachment bracket datums defining the glass panel attachment bracket predetermined positions, a plurality of glass panel datums defining a predetermined orientation of the glass panel, and a plurality of glass panel support bosses.

In the following description, there are shown and described several preferred embodiments of the described adjustable attachment bracket for a glass panel. As it should be realized, the device is capable of other, different embodiments and its several details are capable of modification in various, obvious aspects all without departing from the adjustable attachment bracket for a glass panel as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the adjustable attachment bracket for a glass panel and together with the description serve to explain certain principles thereof. In the drawing figures:

FIG. 1A is a sectional side view of an adjustable glass panel attachment bracket according to the present disclosure, secured to a window glass panel;

FIG. 1B shows the adjustable glass panel attachment bracket of FIG. 1A in isolation;

FIG. 2 shows an alternative embodiment of the adjustable glass panel attachment bracket of FIGS. 1A and 1B; and

FIG. 3 shows a template for assembling an adjustable glass panel attachment bracket according to the present disclosure to a window glass panel; and

FIG. 4 shows a motor vehicle door having a door window glass mounting assembly including the adjustable glass panel attachment bracket according to the present disclosure.

Reference will now be made in detail to the present preferred embodiments of the adjustable attachment bracket for a glass panel, examples of which are illustrated in the accompanying drawing figures.

### DETAILED DESCRIPTION

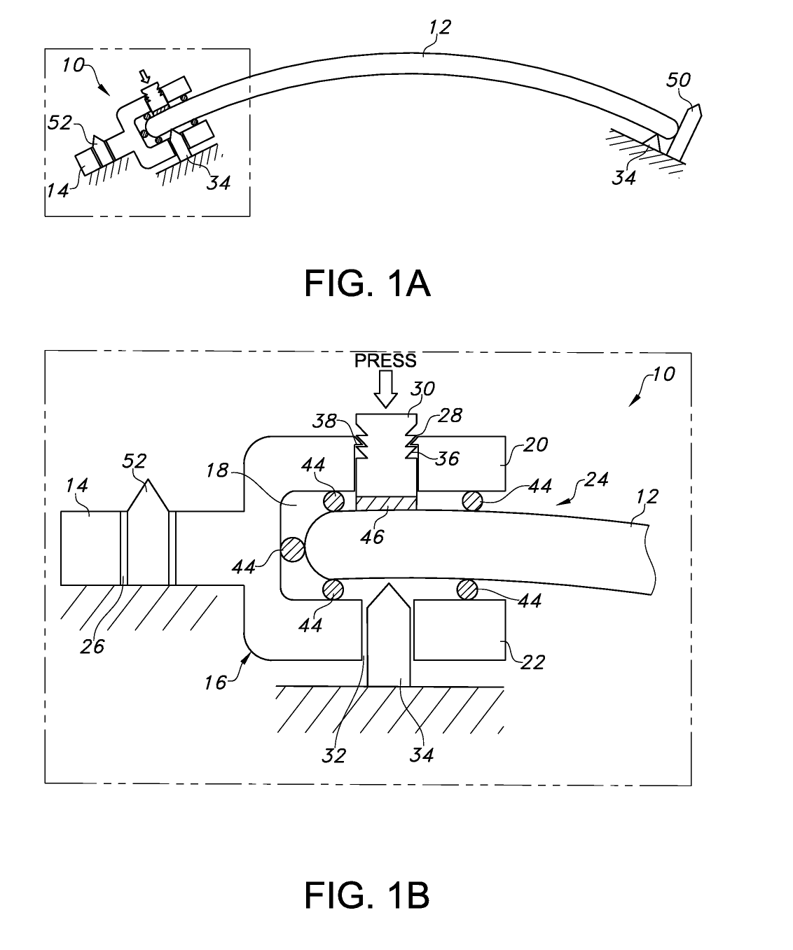

Reference is now made to FIG. 1A illustrating an adjustable glass panel attachment bracket 10 according to the present disclosure, secured to a curved glass panel 12. FIG. 1B shows the adjustable glass panel attachment bracket 10 of FIG. 1A in isolation. The adjustable bracket 10 includes an arm 14 carrying a receiver 16. The receiver 16 is defined by a bottom 18 and may include two opposed walls 20, 22 defining a slot or channel 24 therebetween for receiving a portion of a glass panel 12 therein. Arm 14 may include an aperture 26, the purpose of which will be described in greater detail below.

As shown in FIG. 1B, wall 20 includes an aperture 28 configured to receive at least one fastener 30 therethrough. The opposed wall 22 may include at least one aperture 32 configured to receive a glass panel support boss 34 therethrough. The depicted embodiment of fastener 30 includes a ratcheting surface 36 for interacting with a cooperating lip 38 associated with aperture 28. As will be appreciated, this structure allows advancing fastener 30 through aperture 28 in one direction only (see arrow), to impinge on a surface of glass panel 12 held within receiver 16. In turn, glass support boss 34 provides a contact point for a surface of glass panel 12 opposite to that impinged on by fastener 30, thus keeping glass panel 12 substantially centered within receiver 16.

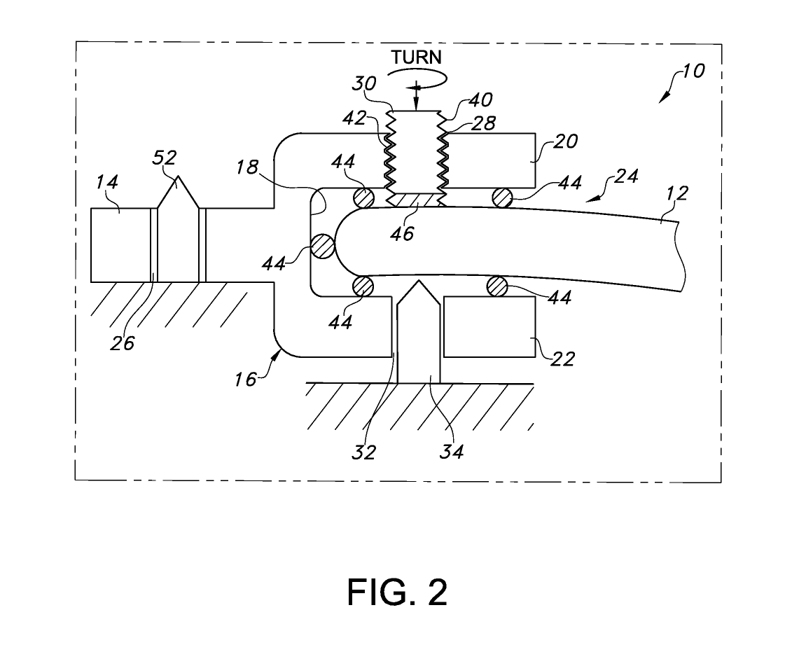

It will be appreciated that a variety of configurations of fastener 30 are contemplated for engaging the aperture 28, including without intending any limitation an interference fit, a friction fit, a press fit, a snap fit, a ratcheting surface, and a screwthread. For example, as shown in FIG. 2, an alternative embodiment of fastener 30 may include a screwthreaded surface 40 which engages a cooperating screwthreaded interior surface 42 of aperture 28 for advancing the fastener 30. In turn, while the drawings depict an embodiment of adjustable glass panel attachment bracket 10 having a single fastener 30, it will be appreciated that alternative embodiments may include one or more fasteners 30 in accordance with a size of bracket 10, a weight of glass panel 12, etc. All such alternative embodiments are contemplated for use herein.

In use, one or more beads 44 of a suitable glass adhesive are applied to an interior of receiver slot 24, and glass panel 12 is inserted therein. Any number of suitable glass adhesives are known in the art and are contemplated for use herein. Next, a layer 46 of a suitable bond or other adhesive is applied to a surface of fastener 30 that will impinge on glass panel 12. Any number of suitable bond adhesives are known in this art and are contemplated for use herein. A caveat is that a bond adhesive is selected having a rapid curing time. Then, fastener 30 is advanced such as by pressing (FIGS. 1A, 1B) or turning (FIG. 2) to advance the fastener through aperture 28 to impinge on a portion of glass panel 12 held within receiver 16.

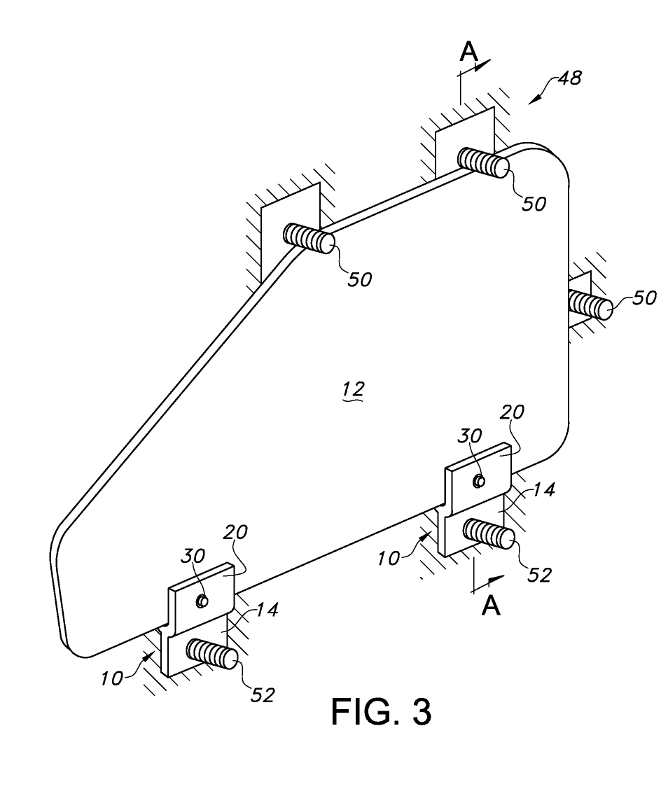

This process can be performed using a jig or template 48 as shown in FIG. 3. At least one glass datum 50 is included for preserving glass panel 12 in a desired orientation/position. In turn, one or more bracket datums 52 are included to provide predetermined fixed positions at which adjustable glass panel attachment brackets 10 are desired to be positioned. Bracket datums 52 pass through apertures 26 of the adjustable glass panel attachment bracket arms 14. As will be appreciated, the specific positioning of the glass datums 50 and bracket datums 52 will be determined by specific shapes/configurations of glass panels 12 and by specific window glass mounting assemblies (not shown in this view) into which the assembled glass panel 12/adjustable glass panel attachment bracket 10 will be incorporated. Thus, the specific positioning of glass datums 50/bracket datums 52 shown in FIG. 3 is not to be taken as limiting.

As is known, glass adhesives required an extended curing time. As a non-limiting example, many glass adhesives commonly in use in this art require up to 72 hours to fully cure. However, it is often the case during manufacturing that one or more glass panel attachment brackets will be secured to a glass panel by a suitable adhesive, and then immediately the assembly will be removed to a different area of the manufacturing facility for subsequent processing and or packaging. As will be appreciated, because often this occurs before the glass adhesive has had time to cure, shifting of the bracket relative to the glass panel may occur resulting in a poor quality part and/or problems in fit and function of the glass panel/attachment bracket assembly, for example in a vehicle door.

The present disclosure solves this problem. By use of the fastener 30 and bond adhesive layer 46 and template 48 as described above, one or more adjustable glass panel attachment brackets 10 may be attached to a glass panel 12. Once the bond adhesive 46 has cured, the assembly may be removed from the template 48. Because the bond adhesive layer 46 cures rapidly, fastener 30 retains the relative positioning of adjustable glass attachment bracket 10 and glass panel 12 even though glass adhesive 44 has not yet cured. Thus, shifting and/or movement of the adjustable glass panel attachment bracket 10 relative to the glass panel 12 is prevented, thus allowing for movement of the bracket 30/panel 12 assembly for subsequent processing/packaging prior to full curing of the glass adhesive 44.

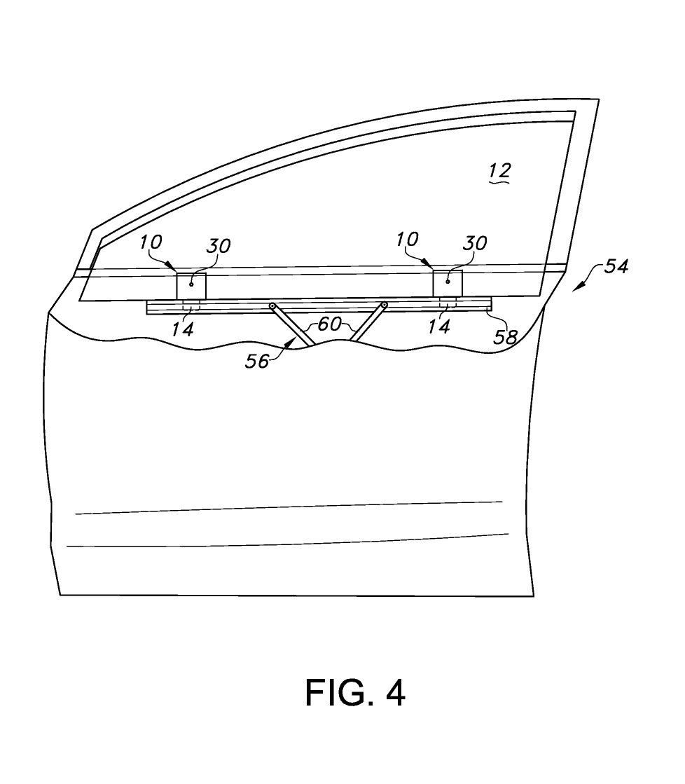

FIG. 4 depicts an assembled glass panel 12/adjustable glass panel attachment bracket 10 assembly incorporated into a vehicle door assembly 54 and a window glass mounting assembly 56. It will be appreciated that a wide variety of vehicle door assemblies and window glass mounting assemblies are known in the art. Likewise, a variety of mechanisms for raising and lowering a vehicle door window are known. All such embodiments are contemplated for use herein, and as will be seen by the skilled artisan, the mechanisms described below will readily incorporate into such embodiments.

As shown, the door assembly 54 includes a window glass mounting assembly 56 having at least a base 58 and a mechanism (depicted generally in the embodiment shown as arms 60) for raising and lowering the base 58 and so a glass panel 12 attached thereto within an interior cavity of door assembly 54. Of course, such mechanisms for raising and lowering window glass in a vehicle door include additional features such as motors, gearing, guide rails, guide brackets, pulleys, cables, window crank arms, etc. Such features are well known in the art and do not require extensive description herein. The adjustable glass panel attachment brackets 10 may be attached to base 58 by fasteners (not shown in this view) passing through apertures 26 of arms 14.

As will be appreciated, the above-described features provide a simple, reliable system for preparing an assembled glass panel 12/attachment bracket 10 for subsequent incorporation into a vehicle, for example into a vehicle door assembly 54 as described above. The skilled artisan will appreciate that by use of the adjustable glass panel attachment bracket 10 described herein, advantageously the manufacturer need not await a full curing time for a glass adhesive before the assembled glass panel 12/attachment bracket 10 can be moved down the manufacturing line for additional processing and/or packaging. Thus, manufacturing and labor costs are reduced, while preserving quality, fit, and function of the assembled part.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A glass panel attachment bracket, comprising:
a receiver for receiving at least a portion of a glass panel, the receiver including at least one adjustable fastener adapted for impinging on a surface of the portion of the glass panel received in the receiver.

2. The bracket of claim 1, wherein the receiver includes a bottom and two opposed walls defining a slot configured to receive the portion of the glass panel therein, one of the opposed walls including at least one aperture for receiving the at least one adjustable fastener therethrough.

3. The bracket of claim 2, wherein the at least one adjustable fastener engages the at least one aperture by an interference fit, a friction fit, a press fit, a snap fit, a ratcheting surface, or a screwthread.

4. The bracket of claim 2, wherein the other of the opposed walls includes at least one aperture for receiving a glass panel support boss therethrough.

5. The bracket of claim 1, wherein the receiver is carried by an arm including at least one aperture therethrough.

6. A motor vehicle door window glass mounting assembly, comprising:
a base adapted for raising and lowering within a cavity defined in the door; and
at least one glass panel attachment bracket mounted to the base and defining a receiver for receiving at least a portion of a glass panel;
wherein the receiver further includes at least one adjustable fastener adapted for impinging on a surface of the portion of the glass panel received in the receiver.

7. The window glass mounting assembly of claim 6, wherein the receiver includes a bottom and two opposed walls defining a slot configured to receive the portion of the glass panel therein, one of the opposed walls including at least one aperture for receiving the at least one adjustable fastener therethrough.

8. The window glass mounting assembly of claim 7, wherein the at least one adjustable fastener engages the at least one aperture by an interference fit, a friction fit, a press fit, a snap fit, a ratcheting surface, or a screwthread.

9. The window glass mounting assembly of claim 6, wherein the receiver is carried by an arm adapted for attachment to the base.

10. A motor vehicle door assembly including the window glass mounting assembly of claim 6.

11. A motor vehicle including the door assembly of claim 10.

12. A method for securing one or more glass panel attachment brackets to a glass panel, comprising:
providing the one or more glass panel attachment brackets each defining a receiver for receiving at least a portion of a glass panel, each receiver including at least one adjustable fastener having a mating surface for impinging on the portion of the glass panel received in the receiver;
applying a first adhesive to an interior of the attachment bracket receiver;
applying a second adhesive to the adjustable fastener mating surface, the second adhesive having a curing time that is less than a curing time of the first adhesive;
disposing the one or more glass panel attachment brackets at predetermined positions on an edge of the glass panel; and
advancing the at least one adjustable fastener to impinge the mating surface and second adhesive on the glass panel.

13. The method of claim 12, including providing the one or more glass panel attachment brackets each defining a receiver including a bottom and two opposed walls defining a slot configured to receive the portion of the glass panel therein, one of the opposed walls including at least one aperture for receiving the at least one adjustable fastener therethrough.

14. The method of claim 13, including providing the one or more glass panel attachment brackets each including at least one adjustable fastener engaging the at least one aperture by an interference fit, a friction fit, a press fit, a snap fit, a ratcheting surface, or a screwthread.

15. The method of claim 13, including attaching the one or more glass panel attachment brackets to the glass panel on a template having at least:
one or more glass panel attachment bracket datums defining the glass panel attachment bracket predetermined positions;
a plurality of glass panel datums defining a predetermined orientation of the glass panel; and
a plurality of glass panel support bosses.

16. The method of claim 15, including providing the one or more glass panel attachment brackets wherein the other of the opposed receiver walls includes at least one aperture for receiving one of the one or more glass panel support bosses therethrough.

17. The method of claim 16, including providing the one or more glass panel attachment brackets each defining a receiver carried by an arm including at least one aperture therethrough.
